(19) United States
(12) Patent Application Publication
(10) Pub. No.: US 2015/0335200 A1
(43) Pub. Date: Nov. 26, 2015

(54) GRIDDLE

(71) Applicant: Viking Range, LLC, Greenwood, MS (US)

(72) Inventor: Matthew L. Ortner, Greenwood, MS (US)

(73) Assignee: Viking Range, LLC

(21) Appl. No.: 14/533,925

(22) Filed: Nov. 5, 2014

Related U.S. Application Data
(63) Continuation-in-part of application No. 14/479,839, filed on Sep. 8, 2014.
Application No. 14/479,839 is a continuation-in-part of application No. 14/286,514, filed on May 23, 2014.

(51) Int. Cl. A47J 37/06

(52) U.S. Cl. CPC A47J 37/067; A47J 37/0676

(57) ABSTRACT

A griddle (10) is disclosed which includes a base (11) and a griddle plate (13). The base includes a frame (15) and a removable grease trough (16). The frame includes sidewalls (18) with top surface (22) having a grease collection channel (23) with a capture hole (24) located so that liquids within the grease collection channel flow through the grease capture hole and into the grease trough. The base has a grease trough well (26) configured to receive the grease trough therein. The grease trough includes a trough collection catch (28) with a sump (32), a handle base (29), and a thermally insulative handle or handle insert (30). The griddle plate has a top surface (38) and a stepped bottom surface (39) defined by a peripheral side edge (40). The stepped bottom surface includes a groove (44) which forms a drip edge (45) positioned above the grease collection channel.

### REFERENCE TO RELATED APPLICATION

This is a continuation-in-part of U.S. patent application Ser. No. 14/479,839 filed Sep. 8, 2014 which is a continuation-in-part of U.S. patent application Ser. No. 14/286,514 filed May 23, 2014.

### TECHNICAL FIELD

This invention relates generally to griddles, and more particularly to stove-top griddles.

### BACKGROUND OF THE INVENTION

Griddles used for cooking food have existed for many years. These cooking griddles typically include a generally flat cooking surface which is positioned above a gas burner or heating element incorporated into the griddle or separate and apart from the griddle such as in a cooktop. The cooking surface may be elevated above a peripheral channel which collects any food juices, such as grease, coming from the cooked food.

A problem with these types of griddles has been the disposal of the collected food juices once the cooking process is completed. Oftentimes, the griddle must be carefully removed, transported and then tilted to pour the captured food juices from the peripheral trough. This task can be difficult due to the temperature of the griddle handle and the large area of the cooking surface to negotiate during its movement and pouring process.

Accordingly, there is a need in the art for a griddle from which it will be easier to capture and later expel the captured food juices and clean the cooking surface. It is to the provision of such therefore that the present invention is primarily directed.

### SUMMARY OF THE INVENTION

In a preferred form of the invention a griddle comprises a base having a central opening defined by internal walls, and a cooking plate removably coupled to the base. The cooking plate has a peripheral edge, a first cooking surface and a second cooking surface opposite the first cooking surface. One of the cooking surfaces has an inboard edge spaced from the peripheral edge configured to nest within the base central opening closely adjacent the internal walls.

### BRIEF DESCRIPTION OF THE DRAWING

FIG. 1 is a perspective view of the griddle embodying principles of the invention in a preferred form.

FIG. 2 is an exploded, perspective view of the griddle of FIG. 1, shown with a griddle plate removed from a base.

FIG. 3 is an exploded, perspective view of a grease trough of the griddle of FIG. 1.

FIGS. 4-6 are a series of cross-sectional view of a portion of the griddle of FIG. 1.

FIG. 7 is a cross-sectional side view of a portion of a griddle plate in another preferred form of the invention.

### DETAILED DESCRIPTION

With reference next to the drawings, there is shown a griddle 10 according to the present invention. The griddle 10 includes a peripheral base 11, made of a metal such as aluminum. The griddle 10 also includes a cooking area, cooking plate, or griddle plate 13 removably mounted to the base 11.

The base 11 includes a peripheral frame 15 and a grease trough or drip tray 16 removably mounted to a front end 17 of the frame 15. The frame 15 includes four peripheral or external walls or sidewalls 18 which form a bottom recess 19 extending to a top opening 20 defined by internal walls or sidewalls 21. The rear sidewall 18′ opposite the front end 17 preferably has an elevated bottom edge in a higher position than the other three sidewalls so that the heat captured within the bottom recess 19 escapes below the rear sidewall 18′ and away from the user. The frame 15 also has a top surface 22 which includes a downwardly extending peripheral grease collection channel 23. The term grease as used herein is intended to encompass all types of food juices produced while cooking them. The grease collection channel 23 has a floor 25 which is sloped or tilted downwardly towards a grease exit port or capture hole 24 located adjacent the grease trough 16, so that liquids contained within the grease collection channel 23 flow towards and through the grease capture hole 24. The front end 17 of the base 11 has a generally L-shaped grease trough receptacle or well 26 which is configured to receive the grease trough 16 therein. The grease trough well 26 may be removably mounted to the rest of the frame to enable it to be separated for better cleaning. The peripheral sidewalls 18 are taller in height or elevation than the internal sidewalls 21 to insure that the griddle plate 13 stays within the confines of the base should it be accidentally bumped or tilted.

The grease trough 16 includes a trough collection catch 28, a handle base 29, and a thermally insulative handle or handle insert 30, as best shown in FIG. 3. The grease trough collection catch 28 has a lower collection sump 32 extending from an upper, handle flange 33 having three mounting screw holes 34 therethrough. The trough collection catch 28 and handle base 29 are made of a metal such as aluminum.

The handle base 29 has two oppositely disposed ends 46 and a generally flat span 47 bridging the ends 46. The span 47 has three mounting holes 35 that align with screw holes 34. The handle insert 30 has a top surface 49 and an opposite bottom surface 50. The handle insert 30 has a large overhanging portion or gripping portion 51 which includes an upwardly extending recess 52 extending from the bottom surface 50 which is defined by sidewalls 53 on all four sides. The rearward most sidewall 53′ forms a lip which aids in preventing an operator's fingers from sliding off the gripping portion and hitting the hot cooking area when in use. The handle insert 30 also includes three threaded screw mounting holes 54 therein. The gripping portion 51 overhangs a portion of the sump 32. The handle insert 30 is made of a thermally insulative, heat resistant plastic or the like. Alternatively, the handle insert 30 may be snap-fitted onto the handle base 29 with mounting screws 36 only passing through screw holes 34 and 35.

The three mounting screw holes 34 of the trough collection catch handle flange 33 are aligned with mounting screw holes 35 within the handle base 29 and threaded mounting screw holes 54 within the handle insert 30. Mounting screws 36 pass through screw holes 34, 35 and 54 to thereby couple the handle insert 30 and handle base 29 to the trough collection catch 28.

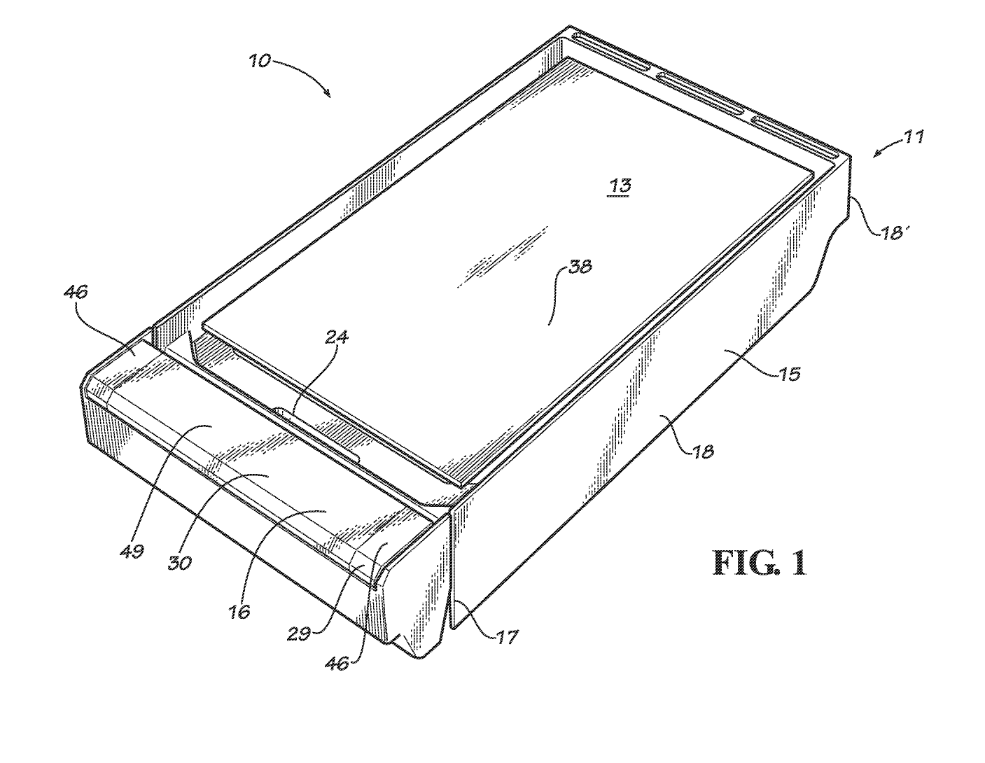

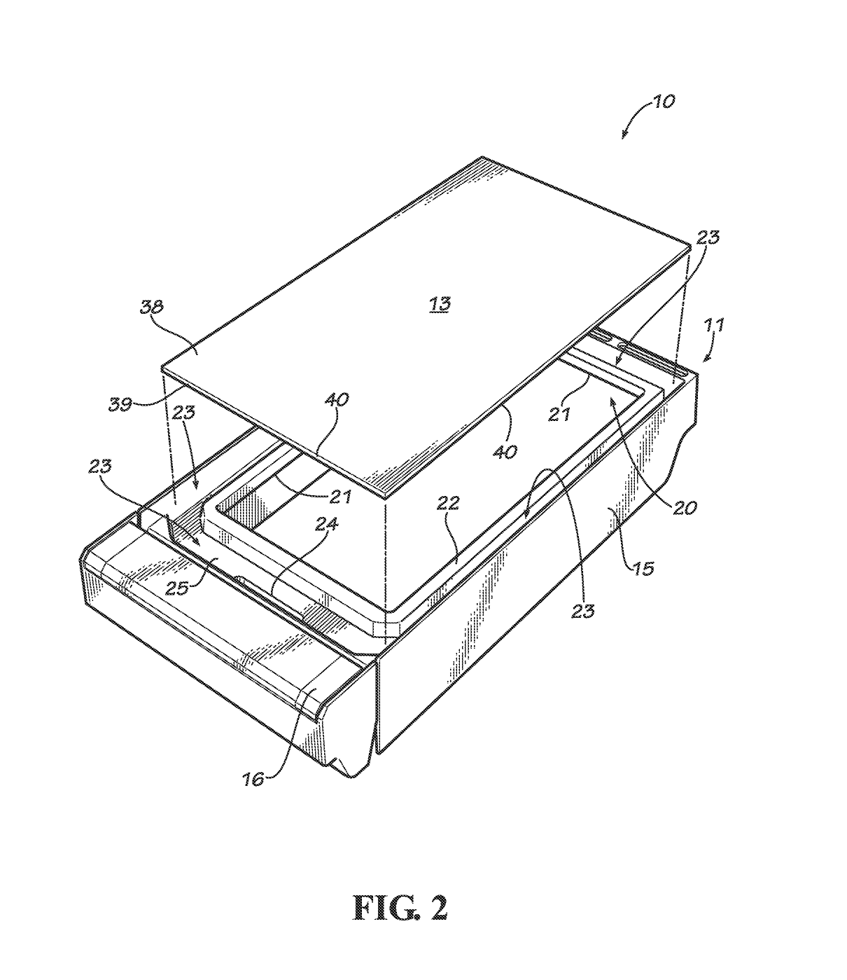

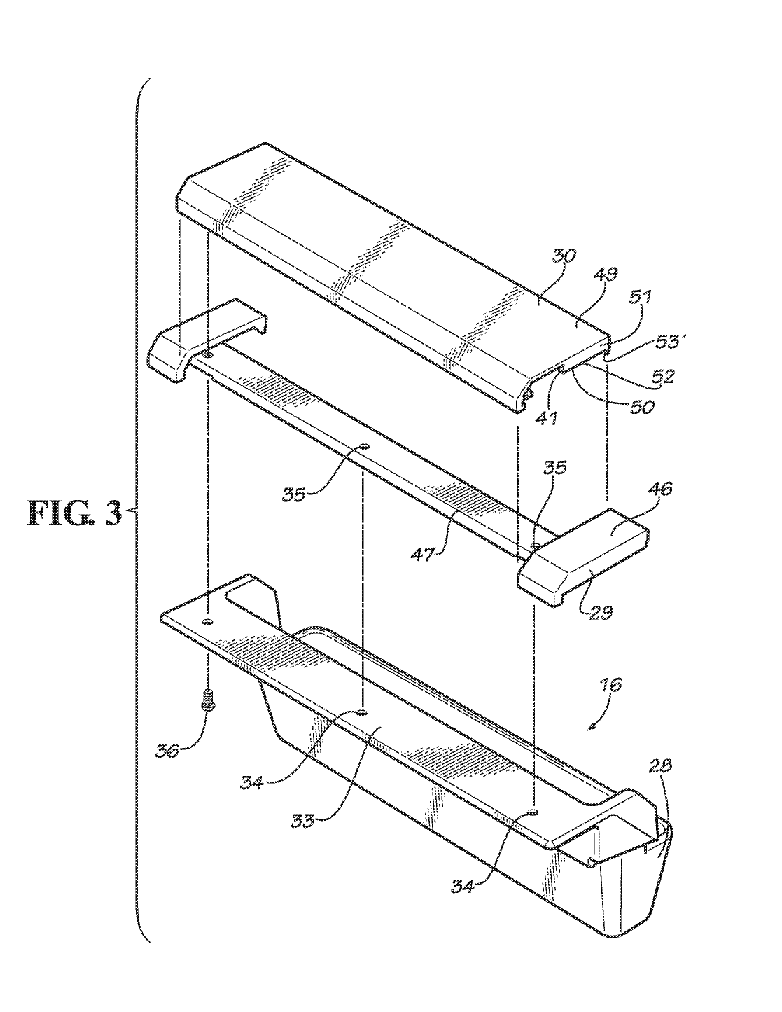

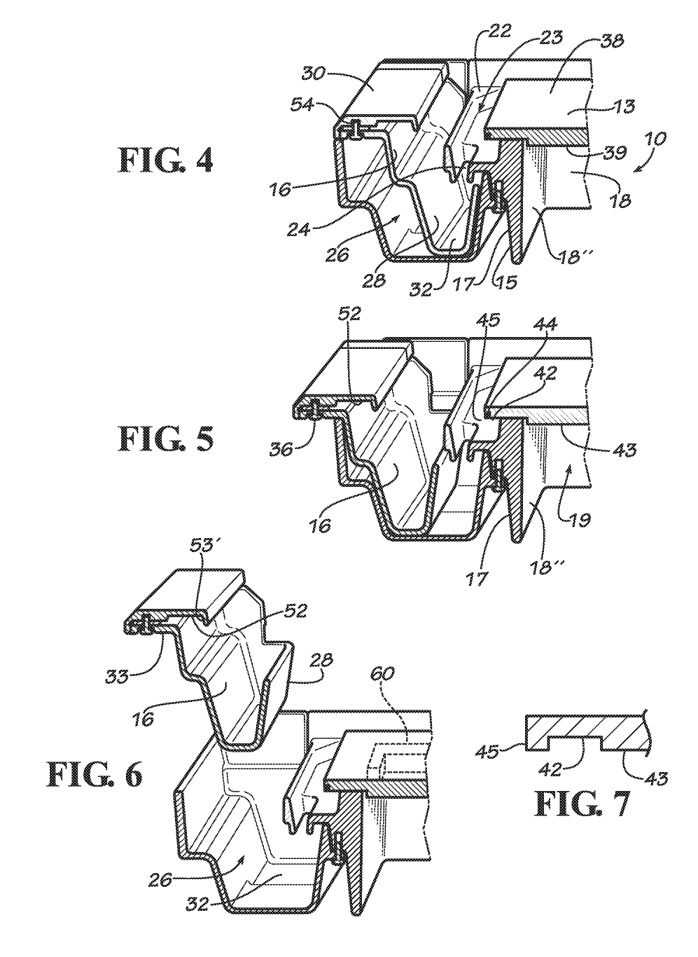

The grease trough 16 is configured to be movable within the grease trough well 26 between a first, in-use position, shown in FIG. 4, a second, disengaged position, shown in FIG. 5, and a third, removed position, as shown in FIG. 6. The handle insert 30 extends over the collection sump 32 to provide a grip or gripping area for the user. With the grease trough 16 in its in-use position, the collection sump 32 is positioned below the grease capture hole 24 so that food juices passing through the grease capture hole 24 are deposited into the underlying collection sump 32. Additionally, while in the in-use position the handle insert 30 abuts the front sidewall 18″ so as to cover the exposed or open top area of the underlying trough catch to prevent direct access to the grease captured therein and prevent the splattering of grease from the grease trough onto the user and the surrounding area, as best shown in FIG. 1 wherein the handle insert is depicted substantially flush with or abutting the front wall and the remaining portions of the grease trough 16 are obscured from view by the handle insert.

The griddle plate 13 is generally planar with a top surface 38 and a stepped bottom surface 39 defined by a peripheral side edge 40. Both the top surface and the bottom surface may be a cooking surface with different surface configurations, depending upon which surface is facing upwardly during the cooking process. The stepped bottom surface 39 includes a peripheral margin area 42 and a thicker central area 43 defined by a ledge or step 41. The margin area 42 includes an upwardly extending groove 44 which forms, in combination with the peripheral side edge 40, a peripheral drip lip or edge 45. The drip edge 45 is positioned directly above the grease collection channel 23. The griddle plate central area 43 is configured to be received or nested within the top opening 20, which aids in maintaining the position of the griddle plate 13 relative to the underlying base 11. The griddle plate 13 is preferably made of a high thermally conductive metal, such as a chrome plated stainless steel.

In use, the griddle 10 is positioned over the heat source, such as a gas burner, of a cooktop. Preferably, the griddle 10 is positioned over the gas burner with the normal or customary burner grates removed, i.e., the griddle replaces the burner grates and does not rest upon them. The griddle sidewalls 18 act to trap the majority of the heat within the bottom recess 19 so that an even heat is applied to the overlaying griddle plate 13.

As food is cooked upon the griddle plate 13, grease and/or other types of food juices flow over the top surface 38 of the griddle plate 13. As these juices reach the peripheral side edge 40 of the griddle plate, the juices flow downwardly along the side edge 40 and upon reaching the margin bottom surface 39 the juices drip or drop into the underlying grease collection channel 23. If the juice somewhat adheres to the margin bottom surface 39 the peripheral groove 44 or undercut described hereinafter, prevents further travel or flow along the bottom surface and thereby causes the juices to drop or drip, i.e., the groove 44 forms the drip edge 45 which prevents juices from flowing along the bottom surface 39 of the griddle plate 13.

As the juice drop into the grease collection channel 23 it gravitationally flows through the sloped grease collection channel 23 towards the lower positioned grease capture hole 24. The juice then flows through the grease capture hole 24 and drops into the underlying collection sump 32 of the grease trough 16.

Once the food has completed cooking and the user wishes to remove the juice from the grease trough, the grease trough 16 is simply moved or slid from its collection position, shown in FIG. 4, to a disengaged position, shown in FIG. 5. This is accomplished by moving the grease trough 16 toward the frame front end 17 by pulling or pushing upon the handle insert 30 in this direction. The user then grasps the handle insert 30 and lifts the grease trough 16 from the grease trough well 26 to its completely removed position separate and apart from the base 11, as shown in FIG. 6. The juice within the grease trough collection sump 32 may then be poured out of the collection sump and properly disposed.

The thermally insulative characteristics of the handle insert 30 allows the grease trough 16 to be handled immediately after the cooking process is complete, as heat is restricted from being transferred from the grease trough to the user's hands. This is a vast improvement over prior art griddles that utilize metal handles which get hot with the use of the griddle, making them difficult to grasp and handle. This ability to handle the grease trough while still hot allows for better clean-up and disposal of juices, such as grease, as such juices flow better while at a high temperature. The bottom recess 52 within the handle insert 30 insures that a person's fingers will not move too close to and encounter the possibly hot portions of the griddle, i.e., the recess helps to maintains the fingers upon the handle insert. The front sidewall 53′ of the recess aids in preventing the fingers from slipping off the rearward end of the handle insert, especially when lifting the grease trough.

It should be understood that as an alternative to the groove 44, a portion of the griddle plate spaced from the side edge 40 may be undercut so that the side edge 40 depends lower than the undercut portion to form the downwardly extending drip lip, as shown in FIG. 7.

It should be understood that even though the description herein primarily refers to a gas burner, any alternative heat form may also be utilized, such as charcoal, electric heating elements, and other conventionally known heating means.

It should be understood that as an alternative to the use of the griddle atop an existing burner, a heat source may be incorporated into the griddle so that it is a stand alone structure.

Last, it should be understood that the removable feature of the griddle plate is desirable to enable different types of griddle plates to be used and switched at any time. The removable feature is also desirous as this allows for the use of multiple griddle plates of different surface configurations to be used. The griddle plate may also include a step 41 on both surfaces, show in phantom lines in the form of a ridge 60 in FIG. 6.

While this invention has been described in detail with particular reference to the preferred embodiments thereof and the best mode of practicing same, it will be understood that variations and modifications can be effected within the spirit and scope of the invention as described herein above and as set forth in the appended claims.

1. A griddle comprising:
a base having a central opening defined by internal walls, and
a cooking plate removably coupled to said base, said cooking plate having a peripheral edge, a first cooking surface and a second cooking surface opposite said first cooking surface, one said cooking surface having an inboard edge spaced from said peripheral edge configured nest within said base central opening closely adjacent said internal walls.

2. The griddle of claim 1 wherein said base has external walls defining a periphery of said base having a first select height, and wherein said internal walls have a second select height lower in elevation than said external walls first select height.

3. The griddle of claim 1 wherein said base includes a floor extending between said external walls and said internal walls which in combination with said external walls and said internal walls defines a collection channel.

4. The griddle of claim 1 wherein at least one said cooking surface has a groove spaced from said peripheral edge so as to create a peripheral lip.

5. The griddle of claim 1 wherein both said first cooking surface and said second cooking surface include inboard edges spaced from said peripheral edge configured to nest within said base central opening closely adjacent said internal walls.

6. The griddle of claim 3 wherein said collection channel includes a capture hole, and wherein said griddle further comprises a collection catch removably mounted to said base.

7. The griddle of claim 6 wherein said collection catch includes a collection sump and a thermally insulative handle.

8. The griddle of claim 7 wherein said gripping portion is positioned at least partially over said collection sump.

9. A griddle comprising:
a base having a peripheral frame defining a top opening and a collection channel directly adjacent said top opening, and
a cooking plate removably coupled to said base, said cooking plate having peripheral edges configured to be positioned directly above said base collection channel.

10. The griddle of claim 9 wherein said collection channel includes a capture hole therethrough, and wherein said base includes a trough well having a portion extending below said collection channel capture hole, and wherein said griddle further comprises a collection catch having a collection sump and a handle, said collection catch being movable between a first position within said trough well wherein said collection sump is positioned directly below said collection channel capture hole, a second position within said trough well wherein said collection sump is not positioned directly below said collection channel, and a third position completely removed from said trough well.

11. The griddle of claim 9 wherein said frame has external walls defining a periphery of said base with a first select height, and internal walls having a second select height lower than said external walls first select height.

12. The griddle of claim 11 wherein said frame includes a floor extending between said external walls and said internal walls which in combination with said external walls and said internal walls defines said collection channel.

13. The griddle of claim 9 wherein said cooking plate has a peripheral edge, first cooking surface and a second cooking surface opposite said first cooking surface, and wherein one said cooking surface has an inboard edge spaced from said peripheral edge configured to nest within said base top opening.

14. The griddle of claim 13 wherein at least one said cooking surface has a groove spaced from said peripheral edge so as to create a peripheral lip.

15. The griddle of claim 13 wherein both said first cooking surface and said second cooking surface include inboard edges spaced from said peripheral edge configured to nest within said base top opening.

16. The griddle of claim 9 wherein said collection channel includes a capture hole, and wherein said griddle further comprises a collection catch removably mounted to said base.

17. The griddle of claim 16 wherein said collection catch includes a collection sump and a thermally insulative handle.

18. The griddle of claim 17 wherein said gripping portion is positioned at least partially over said collection sump.

19. A griddle comprising:
a base having peripheral walls and a central opening defined by internal walls, and
a cooking plate removably coupled to said base, said cooking plate having a peripheral edge, a first cooking surface and a second cooking surface opposite said first cooking surface, said first cooking surface having a first inboard edge spaced from said peripheral edge configured to be received within said base central opening, said second cooking surface having a second inboard edge spaced from said peripheral edge configured to be received within said base central opening.

20. The griddle of claim 19 wherein said base peripheral walls have a first select height, and wherein said base internal walls have a second select height lower in elevation than said peripheral walls first select height.

21. The griddle of claim 19 wherein at least one said cooking surface has a groove spaced from said peripheral edge so as to create a peripheral lip.
